(19) United States
(12) Patent Application Publication
(10) Pub. No.: US 2022/0414602 A1
(43) Pub. Date: Dec. 29, 2022

(54) COLLABORATIVE VISUAL INTERFACE FOR AN OPERATION CONTROL CENTER

(71) Applicant: Johnson Controls Tyco IP Holdings LLP, Milwaukee, WI (US)

(72) Inventor: Jason M. OUELLETTE, Sterling, MA (US)

(21) Appl. No.: 17/809,171

(22) Filed: Jun. 27, 2022

Related U.S. Application Data
(60) Provisional application No. 63/215,705, filed on Jun. 28, 2021.

(51) Int. Cl. G06Q 10/10

(52) U.S. Cl. CPC G06Q 10/103

(57) ABSTRACT

Disclosed herein are apparatuses and methods for managing collaborations in an operation control center. An implementation may comprise identifying, using at least one sensor, a plurality of persons in an operation control center comprising a display device. The implementation may comprise retrieving, from memory, user profiles of a first person and a second person, wherein the user profiles respectively indicate security access rights and responsibilities of the first person and the second person and determining locations of the first person and the second person in the operation control center. The implementation may comprise allocating, on the display device, a first display area to the first person and a second display area to the second person based on the locations, the security access rights, and the responsibilities. The implementation may comprising notifying the first person or the second person of a security event on a display area.

### CROSS-REFERENCE TO RELATED APPLICATIONS

The application claims the benefit of U.S. Provisional Application No. 63/215,705, filed Jun. 28, 2021, which is herein incorporated by reference.

### TECHNICAL FIELD

The described aspects relate to security systems.

### BACKGROUND

Aspects of the present disclosure relate generally to security systems, and more particularly, to providing a collaborative visual interface for an operation control center.

In an operation center where security personnel with varying levels of seniority and security access work together, information overload, lack of cohesion, and miscommunication can cause a loss of time when resolving an issue. This ultimately leads to an unsafe environment. For example, a security team may encounter an incident in a monitored environment (e.g., a fire in an office) and may be unable to resolve the incident in time (e.g., by immediately evacuating the office and putting out the fire) due to a failure in communicating the incident to the right person(s) on the security team and focusing resources around the incident.

Accordingly, there exists a need for improvements in such security systems.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a method for managing collaborations in an operation control center, comprising identifying, using at least one sensor, a plurality of persons in an operation control center, wherein the operation control center comprises a display device accessible to the plurality of persons. The method further includes retrieving, from memory, user profiles of a first person and a second person of the plurality of persons, wherein the user profiles respectively indicate security access rights and responsibilities of the first person and the second person. The method further includes determining locations of the first person and the second person in the operation control center. The method further includes allocating, on the display device, a first display area to the first person and a second display area to the second person based on the locations, the security access rights, and the responsibilities. The method further includes notifying the first person of a security event on the first display area of the display device. The method further includes receiving an escalation request from the first person. The method further includes notifying the second person of the security event on the second display area of the display device in response to receiving the escalation request.

Another example implementation includes an apparatus for managing collaborations in an operation control center, comprising a memory and a processor communicatively coupled with the memory. The processor is configured to identify, using at least one sensor, a plurality of persons in an operation control center, wherein the operation control center comprises a display device accessible to the plurality of persons. The processor is configured to retrieve, from memory, user profiles of a first person and a second person of the plurality of persons, wherein the user profiles respectively indicate security access rights and responsibilities of the first person and the second person. The processor is configured to determine locations of the first person and the second person in the operation control center. The processor is configured to allocate, on the display device, a first display area to the first person and a second display area to the second person based on the locations, the security access rights, and the responsibilities. The processor is configured to notify the first person of a security event on the first display area of the display device. The processor is configured to receive an escalation request from the first person. The processor is configured to notify the second person of the security event on the second display area of the display device in response to receiving the escalation request.

Another example implementation includes an apparatus for managing collaborations in an operation control center, comprising means for identifying, using at least one sensor, a plurality of persons in an operation control center, wherein the operation control center comprises a display device accessible to the plurality of persons. The apparatus further includes means for retrieving, from memory, user profiles of a first person and a second person of the plurality of persons, wherein the user profiles respectively indicate security access rights and responsibilities of the first person and the second person. The apparatus further includes means for determining locations of the first person and the second person in the operation control center. The apparatus further includes means for allocating, on the display device, a first display area to the first person and a second display area to the second person based on the locations, the security access rights, and the responsibilities. The apparatus further includes means for notifying the first person of a security event on the first display area of the display device. The apparatus further includes means for receiving an escalation request from the first person. The apparatus further includes means for notifying the second person of the security event on the second display area of the display device in response to receiving the escalation request.

Another example implementation includes a computer-readable medium storing instructions for managing collaborations in an operation control center, executable by a processor to identify, using at least one sensor, a plurality of persons in an operation control center, wherein the operation control center comprises a display device accessible to the plurality of persons. The instructions are further executable to retrieve, from memory, user profiles of a first person and a second person of the plurality of persons, wherein the user profiles respectively indicate security access rights and responsibilities of the first person and the second person. The instructions are further executable to determine locations of the first person and the second person in the operation control center. The instructions are further executable to allocate, on the display device, a first display area to the first person and a second display area to the second person based on the locations, the security access rights, and the responsibilities. The instructions are further executable to notify the first person of a security event on the first display area of the display device. The instructions are further executable to receive an escalation request from the first person. The instructions are further executable to notify the second person of the security event on the second display area of the display device in response to receiving the escalation request.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram of a scenario for managing collaborations in an operation control center, in accordance with exemplary aspects of the present disclosure.

FIG. 2 is a diagram of a plurality of control spaces corresponding to display areas on the display device, in accordance with exemplary aspects of the present disclosure.

FIG. 3 is a block diagram of a computing device executing a security management component, in accordance with exemplary aspects of the present disclosure.

FIG. 4 is a flowchart illustrating a method of managing collaborations in an operation control center, in accordance with exemplary aspects of the present disclosure.

FIG. 5 is a flowchart illustrating a method of allocating display area sizes, in accordance with exemplary aspects of the present disclosure.

FIG. 6 is a flowchart illustrating a method of generating a set of options to resolve a security event, in accordance with exemplary aspects of the present disclosure.

FIG. 7 is a flowchart illustrating a method of handling overriding requests, in accordance with exemplary aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The present disclosure provides definitions of locations and privileges in an operation control center to establish priorities and the right to control (e.g., override, escalate, share, etc.) the use of displays in the room. This configuration is used in conjunction with facial recognition or other biometric or logical identity verifications for the application of privilege, permissions, and controls of data privacy.

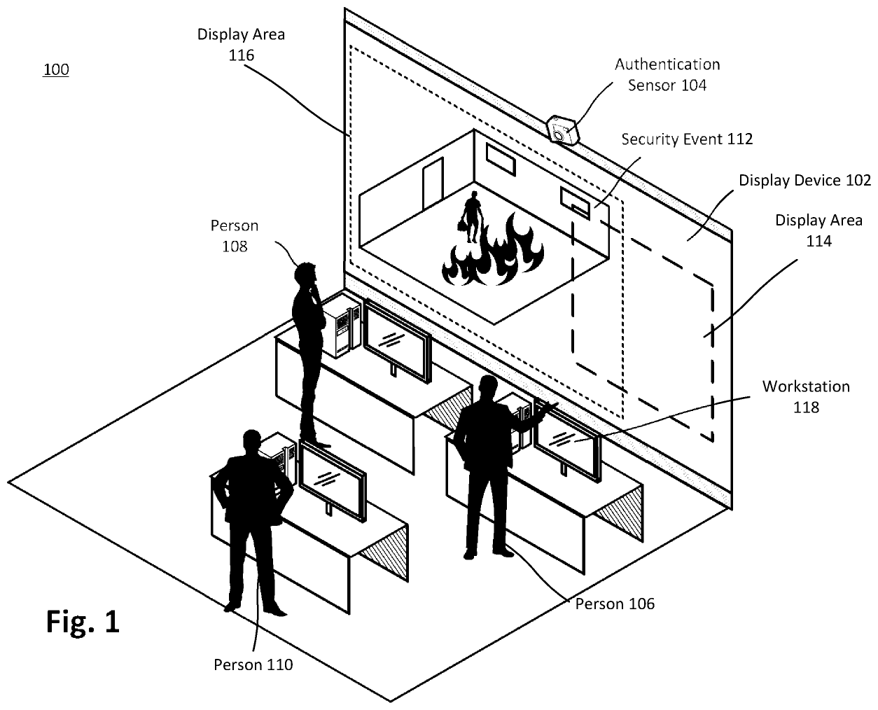

FIG. 1 is a diagram 100 of a scenario for managing collaborations in an operation control center, in accordance with exemplary aspects of the present disclosure. Diagram 100 depicts an operation control center in which security personnel monitors security events detected by an environment security component of the operation control center.

As shown in FIG. 1, the operation control center includes a display device 102 that is accessible to the security personnel including persons 106, 108, and 108. In some aspects, display device 102 covers a wall of the operation control center and expands from a ceiling of the operation control center to a floor of the operation control center. In some aspects, the display device 102 comprises multiple monitors in which at least one monitor is connected to another monitor.

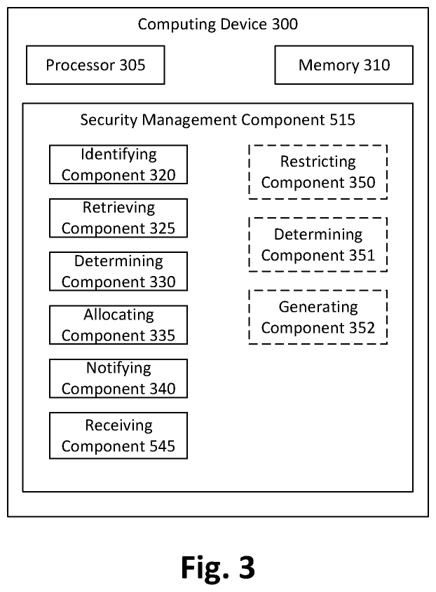

Each person has access to a workstation that enables monitoring of an environment (e.g., an office space). In some cases, a person may be interested in displaying the contents of their screen (i.e., on their workstation) on display device 102 for a collaborative interaction. Suppose that person 106 is responsible for monitoring activity in a certain portion of the environment and that person 108 is responsible for life threatening incidents (e.g., fires, floods, electrical issues, etc.). A security management component (discussed in FIG. 3) may notify person 106 of security event 112 (e.g., a fire) that is taking place in the portion of the environment that person 106 is responsible for monitoring. In some aspects, the notification may be on the workstation of person 106 (e.g., workstation 118) and person 106 may wish to transfer/extend control to person 108 upon realizing that the security event requires higher permissions for handling (e.g., person 106 may not have permissions to activate a security device such as sprinklers to resolve a fire event and thus transfers control to person 108). Person 106 may perform this transfer/sharing using gestures (e.g., captured by sensor 104). In some aspects, the gestures may be converted into commands for accessing content on display device 102 such as moving, opening, re-sizing, acknowledging, clearing, forwarding, closing, escalating, minimizing, overriding, etc.

In order to accommodate this collaboration and enable person 108 to properly resolve security event 112, the security management component may allocate display areas of display device 102 to each of the security personnel. This allocation may be based on the security access rights and responsibilities of each person. The allocation may also be based on the location of each person. The security management component may identify each person in the operation control center and their locations in the room using sensors at the workstations and/or authentication sensor 104. For example, sensor 104 may be a camera that uses facial detection to identify each person (e.g., compare faces against a facial image database) and computer vision techniques such as segmentation to approximate locations in the room.

In FIG. 1, the security management component may determine that person 108 has greater security access rights and responsibilities than person 106. The security management component may further determine that person 108 is on the right side of the operation control center (from the perspective of sensor 104) and person 106 is on the left side. Accordingly, the security management component may allocate display area 116 for person 108 and display area 114 for person 106. In the case of person 110, the security management component may allocate the entire display device 102 in response to determining that person 110 has greater security access rights and responsibilities than person 106 and person 108.

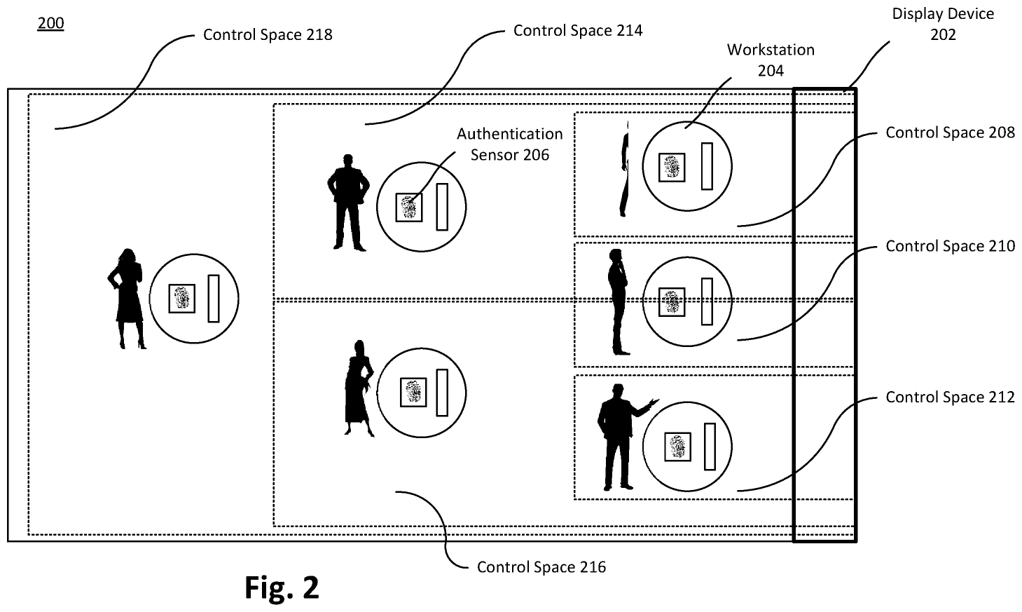

FIG. 2 is a diagram 200 of a plurality of control spaces, e.g., on an area of a floor, corresponding to display areas on the display device, in accordance with exemplary aspects of the present disclosure. FIG. 2 is an overhead view of a operation control center. In diagram 200, multiple persons are accessing display device 202. Each workstation 204 comprises an authentication sensor 206. Sensor 206 may be a card reader (e.g., for ID scans) and/or a biometric sensor (e.g., a fingerprint reader, a facial scanner, etc.). The security management component may allocate a display area to each of the persons based on the location of the control space where they are positioned, and further based on an amount of security access rights and responsibilities of the person. The size and position of the display area (e.g., display area 114 or display area 116 in FIG. 1) on display device 202 is configured based on the control spaces. For example, the security management component may define control spaces 208, 210, and 212 for use by three persons nearest to display device 202. These are the smallest control spaces, signifying that the persons have access to the smallest display areas. The security management component may define control space 214 and 216, e.g., relatively larger areas of the floor, and enable persons in those spaces to have access to larger display areas (i.e., if the location of a person is determined to be within a particular control space, that person is assigned the display area associated with that control space). Similarly, the person located in control space 218 may have access to the largest display area, presumably because the person has the greatest security access rights and responsibilities (e.g., the person may manage all of the remaining persons).

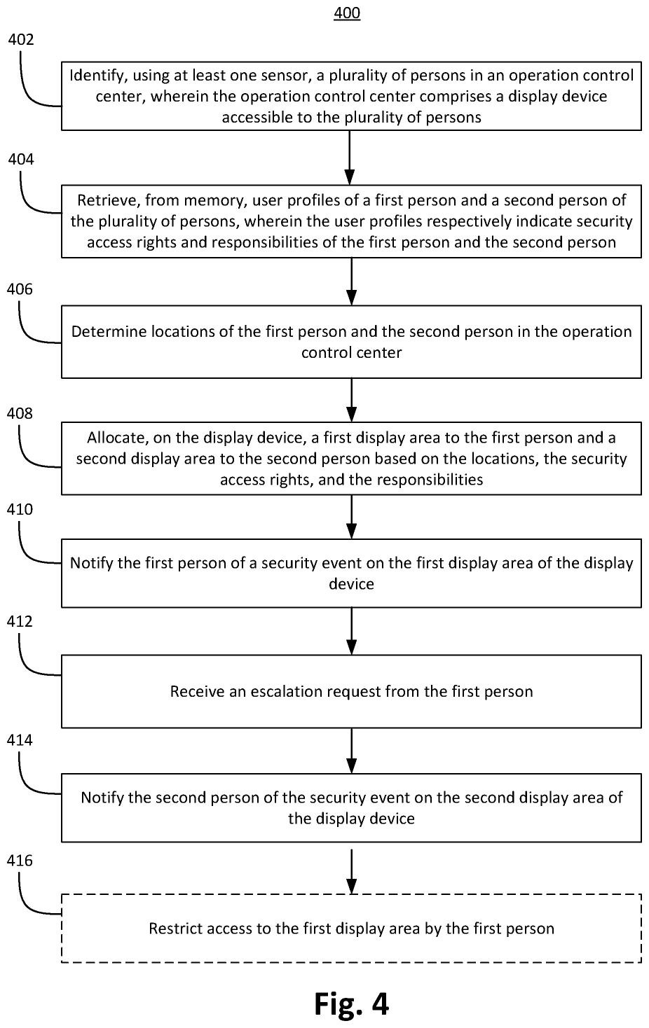

FIG. 3 is a block diagram of computing device 300 executing a security management component 315, in accordance with exemplary aspects of the present disclosure. FIG. 4 is a flowchart illustrating method 400 of managing collaborations in an operation control center, in accordance with exemplary aspects of the present disclosure. Referring to FIG. 3 and FIG. 4, in operation, computing device 300 may perform method 400 via execution of security management component 315 by processor 305 and/or memory 310.

At block 402, method 400 includes identifying, using at least one sensor, a plurality of persons in an operation control center, wherein the operation control center comprises a display device accessible to the plurality of persons. For example, in an aspect, computer device 300, processor 305, memory 310, security management component 315, and/or identifying component 320 may be configured to or may comprise means for identifying, using at least one sensor (e.g., sensor 104, sensor 206), a plurality of persons in an operation control center, wherein the operation control center comprises display device 102 accessible to the plurality of persons (e.g., person 106, 108, and 110).

At block 404, method 400 includes retrieving, from memory, user profiles of a first person and a second person of the plurality of persons, wherein the user profiles respectively indicate security access rights and responsibilities of the first person and the second person. For example, in an aspect, computer device 300, processor 305, memory 310, security management component 315, and/or retrieving component 325 may be configured to or may comprise means for retrieving, from memory 310, user profiles of person 106 and person 108 of the plurality of persons, wherein the user profiles respectively indicate security access rights and responsibilities of the first person and the second person.

Suppose that the environment being monitored by the operation control center is an office building. The security access rights represent authorizations associated with a person. For example, person 106 may be authorized to monitor camera feeds of a particular portion of the office building such as the cafeteria, lobby, and main entrance. The security access rights may also indicate that person 106 is authorized to take control of a subset of security devices in the environment (e.g., security cameras, door locks, keypads, etc.). In contrast, person 110 may have more security rights than person 106. For example, person 110 may be able to monitor all camera feeds that person 106 is able to monitor and may also be authorized to monitor camera feeds from employee offices in the office building.

At block 406, method 400 includes determining locations of the first person and the second person in the operation control center. For example, in an aspect, computer device 300, processor 305, memory 310, security management component 315, and/or determining component 330 may be configured to or may comprise means for determining locations of person 106 and person 108 in the operation control center.

Determining the locations of person 106 and person 108 may include executing computer vision algorithms that detect a person in an image (e.g., captured by sensor 104) and assign a location in the image frame. For example, a pixel associated with person 106 may be located in position (X1, Y1) on the image frame. Determining component 330 may determine that the closest pixel to position (X1, Y1) that belongs to a workstation (e.g., workstation 118) is on position (X2, Y2). Accordingly, determining component 330 may assign the location of workstation 118 to person 106 (i.e., interpreted as person 106 is using workstation 118).

At block 408, method 400 includes allocating, on the display device, a first display area to the first person and a second display area to the second person based on the locations, the security access rights, and the responsibilities. For example, in an aspect, computer device 300, processor 305, memory 310, security management component 315, and/or allocating component 335 may be configured to or may comprise means for allocating, on display device 102, display area 114 to person 106 and display area 116 to person 108 based on the locations, the security access rights, and the responsibilities.

For example, allocating component 335 may reference a database that indicates assignment parameters of different display areas. The assignment parameters may indicate rules for generating, sizing, positioning, and assigning display areas. For example, a first rule may state that display areas 114 and 116 may be generated on display device 102 when two workstations are occupied in the operation control center. A second rule may indicate that display area 114 is to be generated on the right side of display device 102 in front of workstation 118. A third rule may indicate that a size of display area 114 is a function of the amount of authorizations a person has in the security access rights. For example, person 106 may be authorized to access 40 devices, 3 locations, and 80 personnel/event records in the environment. Allocating component 335 may execute a sizing function that receives these numerical values as inputs, and outputs a size. For example, the size of display area 114 may be 30% of the total screen space of display device 102 according to the sizing function.

In some aspects, the sizing function may also consider relative security access rights of each person. For example, person 108 may be authorized to access 80 devices, 4 locations, and 160 personnel/event records in the environment. These numerical values are double the value of the amount of authorizations that person 106 has. Accordingly, the sizing function may indicate that display area 114 should be half the size of display area 116. In this case, both security access rights are provided as inputs to the sizing function.

In some aspects, the second display area includes the first display area. For example, display area 114 may be at least partially inside display area 116.

At block 410, method 400 includes notifying the first person of a security event on the first display area of the display device. For example, in an aspect, computer device 300, processor 305, memory 310, security management component 315, and/or notifying component 340 may be configured to or may comprise means for notifying person 106 of security event 112 on display area 114 of display device 102.

For example, security event 112 may be a fire in the cafeteria area of the office building. Notifying component 340 may generate an alert informing person 106 on display area 114 that a fire has started.

At block 412, method 400 includes receiving an escalation request from the first person. For example, in an aspect, computer device 300, processor 305, memory 310, security management component 315, and/or receiving component 345 may be configured to or may comprise means for receiving an escalation request from person 106.

The escalation request may be a transfer of information in which an appropriate person in the operation control center is given control of handling a security event. For example, security management component 315 may determine, based on the user profiles of the plurality of persons, a second person who should receive control of handling the security event. Suppose that person 108 is selected. In some aspects, the escalation request is received as one of: a gesture, an expression, a physical input, and a verbal input.

At block 414, method 400 includes notifying the second person of the security event on the second display area of the display device in response to receiving the escalation request. For example, in an aspect, computer device 300, processor 305, memory 310, security management component 315, and/or notifying component 340 may be configured to or may comprise means for notifying person 108 of security event 112 (e.g., the fire) on display area 116 of display device 102 in response to receiving the escalation request. This example is shown on FIG. 1.

At block 416, method 400 optionally includes restricting access to the first display area by the first person in response to receiving the escalation request. For example, in an aspect, computer device 300, processor 305, memory 310, security management component 315, and/or restricting component 350 may be configured to or may comprise means for restricting access to display area 114 by person 106 in response to receiving the escalation request. In some aspects, the operation control center further comprises a respective workstation for each of the plurality of persons. Restricting component 350 is further configured to enable the first person to monitor the security event on a workstation of the first person. For example, restricting component 350 may enable person 106 to monitor security event 112 on workstation 118.

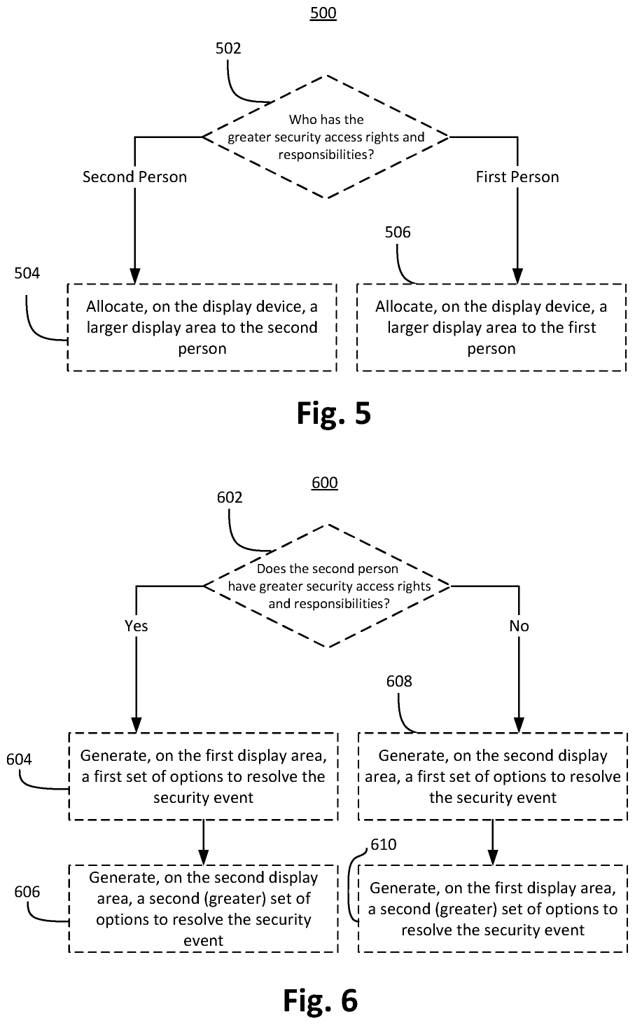

FIG. 5 is a flowchart illustrating method 500 of allocating display area sizes, in accordance with exemplary aspects of the present disclosure.

At block 502, method 500 includes determining, from the first person and the second person, who has the greater security access rights and responsibilities. For example, in an aspect, computer device 300, processor 305, memory 310, security management component 315, and/or determining component 351 may be configured to or may comprise means for determining, from the person 106 and person 108, who has the greater security access rights and responsibilities. If the second person has the greater security access rights, method 500 advances to 504. If the first person has the greater security access rights, method 500 to 506.

At block 504, method 500 includes allocating, on the display device, a larger display area to the second person. For example, in an aspect, computer device 300, processor 305, memory 310, security management component 315, and/or allocating component 335 may be configured to or may comprise means for allocating, on display device 102, a larger display area to person 108.

At block 506, method 500 includes allocating, on the display device, a larger display area to the first person. For example, in an aspect, computer device 300, processor 305, memory 310, security management component 315, and/or allocating component 335 may be configured to or may comprise means for allocating, on display device 102, a larger display area to person 106.

FIG. 6 is a flowchart illustrating method 600 of generating a set of options to resolve a security event, in accordance with exemplary aspects of the present disclosure.

At block 602, method 600 includes determining whether the second person has greater security access rights and responsibilities than the first person. For example, in an aspect, computer device 300, processor 305, memory 310, security management component 315, and/or determining component 351 may be configured to or may comprise means for determining whether person 108 has greater security access rights and responsibilities than person 106. In response to determining that the second person has greater security access rights and responsibilities than the first person, method 600 advances to block 604. Otherwise, method 600 advances to 608.

At block 604, method 600 includes generating, on the first display area, a first set of options to resolve the security event. For example, in an aspect, computer device 300, processor 305, memory 310, security management component 315, and/or generating component 352 may be configured to or may comprise means for generating, on display area 114, a first set of options to resolve security event 112. For example, if security event 112 is a fire detected in the monitored environment, the first set of options may be to call firefighters, activate a fire alarm, and notify building occupants.

At block 606, method 600 includes generating, on the second display area, a second (greater) set of options to resolve the security event. For example, in an aspect, computer device 300, processor 305, memory 310, security management component 315, and/or generating component 352 may be configured to or may comprise means for generating, on display area 116, a second set of options to resolve security event 112. In some aspects, the second set of options includes all of the first set of options and additional options. Following from the previous example, the second set of options may additionally include the options of locking entry into the monitored environment, activating a sprinkler system, and preserving goods in the monitored environment (e.g., backing up data in the computers located in the environment).

At block 608, method 600 includes generating, on the second display area, a first set of options to resolve the security event. For example, in an aspect, computer device 300, processor 305, memory 310, security management component 315, and/or generating component 352 may be configured to or may comprise means for generating, on display area 116, a first set of options to resolve security event 112.

At block 610, method 600 includes generating, on the first display area, the second set of options to resolve the security event. For example, in an aspect, computer device 300, processor 305, memory 310, security management component 315, and/or generating component 352 may be configured to or may comprise means for generating, on display area 114, the second set of options to resolve security event 112.

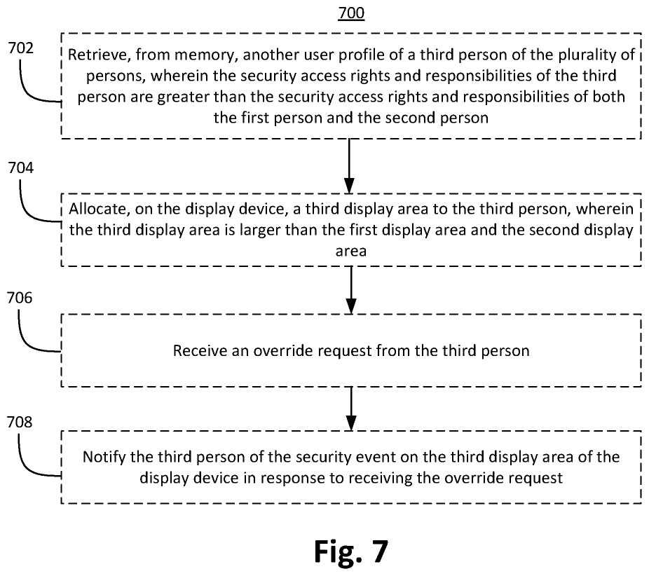

FIG. 7 is a flowchart illustrating method 700 of handling overriding requests, in accordance with exemplary aspects of the present disclosure.

At block 702, method 700 includes retrieving, from the memory, another user profile of a third person of the plurality of persons, wherein the security access rights and responsibilities of the third person are greater than the security access rights and responsibilities of both the first person and the second person. For example, in an aspect, computer device 300, processor 305, memory 310, security management component 315, and/or retrieving component 325 may be configured to or may comprise means for retrieving, from memory 310, another user profile of person 110 of the plurality of persons, wherein the security access rights and responsibilities of person 110 are greater than the security access rights and responsibilities of both person 106 and person 108.

At block 704, method 700 includes allocating, on the display device, a third display area to the third person, wherein the third display area is larger than the first display area and the second display area. For example, in an aspect, computer device 300, processor 305, memory 310, security management component 315, and/or allocating component 335 may be configured to or may comprise means for allocating, on display device 102, a third display area to person 110, wherein the third display area is larger than the first display area and the second display area (e.g., the entire display area of display device 102).

At block 706, method 700 includes receiving an override request from the third person. For example, in an aspect, computer device 300, processor 305, memory 310, security management component 315, and/or receiving component 345 may be configured to or may comprise means for receiving an override request from person 110. For example, the override request may be a command that transfers control of handling a security event to the person requesting the override. It should be noted that security management component 315 may only grant and execute the override request in response to confirming that the requesting person has greater security access rights and responsibilities than the person currently handling the security event.

At block 708, method 700 includes notifying the third person of the security event on the third display area of the display device in response to receiving the override request. For example, in an aspect, computer device 300, processor 305, memory 310, security management component 315, and/or notifying component 340 may be configured to or may comprise means for notifying person 110 of security event 112 on the third display area of the display device in response to receiving the override request.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. An apparatus for managing collaborations in an operation control center, comprising:
a memory;
a processor communicatively coupled with the memory and configured to:
identify, using at least one sensor, a plurality of persons in an operation control center, wherein the operation control center comprises a display device accessible to the plurality of persons; and
retrieve, from the memory, user profiles of a first person and a second person of the plurality of persons, wherein the user profiles respectively indicate security access rights and responsibilities of the first person and the second person;
determine locations of the first person and the second person in the operation control center;
allocate, on the display device, a first display area to the first person and a second display area to the second person based on the locations, the security access rights, and the responsibilities;
notify the first person of a security event on the first display area of the display device;
receive an escalation request from the first person; and
notify the second person of the security event on the second display area of the display device in response to receiving the escalation request.

2. The apparatus of claim 1, wherein the processor is further configured to:
determine that the second person has greater security access rights and responsibilities than the first person; and
allocate, on the display device, a larger display area to the second person, wherein the second display area is larger than the first display area.

3. The apparatus of claim 1, wherein the second display area includes the first display area.

4. The apparatus of claim 1, wherein the escalation request is received as one of: a gesture, an expression, a physical input, and a verbal input.

5. The apparatus of claim 1, wherein the processor is further configured to:
generate, on the first display area, a first set of options to resolve the security event; and
generate, on the second display area, a second set of options to resolve the security event, wherein the second set of options is greater than the first set of options, and wherein a set of options limited by security access rights of a given person.

6. The apparatus of claim 1, wherein the processor is further configured to:
retrieve, from the memory, another user profile of a third person of the plurality of persons, wherein the security access rights and responsibilities of the third person are greater than the security access rights and responsibilities of both the first person and the second person;
allocate, on the display device, a third display area to the third person, wherein the third display area is larger than the first display area and the second display area;
receive an override request from the third person; and
notify the third person of the security event on the third display area of the display device in response to receiving the override request.

7. The apparatus of claim 1, wherein the processor is further configured to:
restrict access to the first display area by the first person in response to receiving the escalation request.

8. The apparatus of claim 7, wherein the operation control center further comprises a respective workstation for each of the plurality of persons, wherein the processor is further configured to:
enable the first person to monitor the security event on a workstation of the first person.

9. The apparatus of claim 1, wherein the display device covers a wall of the operation control center and expands from a ceiling of the operation control center to a floor of the operation control center.

10. A method for managing collaborations in an operation control center, comprising:
identifying, using at least one sensor, a plurality of persons in an operation control center, wherein the operation control center comprises a display device accessible to the plurality of persons; and
retrieving, from memory, user profiles of a first person and a second person of the plurality of persons, wherein the user profiles respectively indicate security access rights and responsibilities of the first person and the second person;
determining locations of the first person and the second person in the operation control center;
allocating, on the display device, a first display area to the first person and a second display area to the second person based on the locations, the security access rights, and the responsibilities;
notifying the first person of a security event on the first display area of the display device;
receiving an escalation request from the first person; and
notifying the second person of the security event on the second display area of the display device in response to receiving the escalation request.

11. The method of claim 10, further comprising:
determining that the second person has greater security access rights and responsibilities than the first person; and
allocating, on the display device, a larger display area to the second person, wherein the second display area is larger than the first display area.

12. The method of claim 10, wherein the second display area includes the first display area.

13. The method of claim 10, wherein the escalation request is received as one of: a gesture, an expression, a physical input, and a verbal input.

14. The method of claim 10, further comprising:
generating, on the first display area, a first set of options to resolve the security event; and
generating, on the second display area, a second set of options to resolve the security event, wherein the second set of options is greater than the first set of options, and wherein a set of options limited by security access rights of a given person.

15. The method of claim 10, further comprising:
retrieving, from the memory, another user profile of a third person of the plurality of persons, wherein the security access rights and responsibilities of the third person are greater than the security access rights and responsibilities of both the first person and the second person;
allocating, on the display device, a third display area to the third person, wherein the third display area is larger than the first display area and the second display area;
receiving an override request from the third person; and
notifying the third person of the security event on the third display area of the display device in response to receiving the override request.

16. The method of claim 10, further comprising:
restricting access to the first display area by the first person in response to receiving the escalation request.

17. The method of claim 16, wherein the operation control center further comprises a respective workstation for each of the plurality of persons, further comprising:
enabling the first person to monitor the security event on a workstation of the first person.

18. The method of claim 10, wherein the display device covers a wall of the operation control center and expands from a ceiling of the operation control center to a floor of the operation control center.

19. A computer-readable medium storing instructions, executable by a processor, for performing a method for managing collaborations in an operation control center, comprising:
identifying, using at least one sensor, a plurality of persons in an operation control center, wherein the operation control center comprises a display device accessible to the plurality of persons; and
retrieving, from memory, user profiles of a first person and a second person of the plurality of persons, wherein the user profiles respectively indicate security access rights and responsibilities of the first person and the second person;
determining locations of the first person and the second person in the operation control center;
allocating, on the display device, a first display area to the first person and a second display area to the second person based on the locations, the security access rights, and the responsibilities;
notifying the first person of a security event on the first display area of the display device;
receiving an escalation request from the first person; and
notifying the second person of the security event on the second display area of the display device in response to receiving the escalation request.
